(19) United States
(12) Patent Application Publication
(10) Pub. No.: US 2024/0163153 A1
(43) Pub. Date: May 16, 2024

(54) CREST FACTOR REDUCTION (CFR) PULSE CANCELLATION (PC) WITH CONFIGURABLE BANDWIDTH AND CENTER FREQUENCY

(71) Applicant: Meta Platforms, Inc., Menlo Park, CA (US)

(72) Inventors: Mohammad JANANI, San Jose, CA (US); Djordje TUJKOVIC, Los Altos, CA (US)

(73) Assignee: Meta Platforms, Inc., Menlo Park, CA (US)

(21) Appl. No.: 17/988,593

(22) Filed: Nov. 16, 2022

Related U.S. Application Data
(60) Provisional application No. 63/293,923, filed on Dec. 27, 2021.

(51) Int. Cl. H04L 27/26

(52) U.S. Cl. CPC H04L 27/2621

(57) ABSTRACT

A system and method for Crest Factor Reduction (CFR) pulse cancellation (PC) in a single carrier environment or multicarrier telecommunication environment may enable obtaining better signal quality while maintaining Peak to Average Power Ratio (PAPR) and/or power efficiency. A PC signal is generated by multiplying a truncated sinc signal with another window signal. The bandwidth of the PC signal may be greater than the bandwidth of the corresponding carrier signal center. The center frequency of the PC signal may be offset with respect to the center frequency for each given carrier in the multi-carrier scenario to fix the edge effect signal quality/interference problems.

### PRIORITY

The present application claims priority under 35 U.S.C. 119(e) to the U.S. Provisional Patent Application Ser. No. 63/293,923, entitled “Crest Factor Reduction (CFR) Pulse Cancellation With Configurable Bandwidth and Center Frequency,” filed on Dec. 27, 2021, the disclosure of which is hereby incorporated by reference in its entirety.

### TECHNICAL FIELD

This non-provisional patent application relates generally to mobile telecommunication systems and methods using Orthogonal Frequency-Division Modulation (OFDM) signals, and more specifically, to systems and methods for using Crest Factor Reduction (CFR) pulse cancellation with configurable bandwidth and center frequency.

### BACKGROUND

A radio transmitter usually comprises a power amplifier (PA) for the transmission of radio signals. The PA may be operated in several different modes of operation, where one of the modes of operation for the PA is chosen based on a compromise between signal distortion and power efficiency. Furthermore, in order to meet the standards for spectrum resource utilization per the constantly changing norms, heavy demands are made on the linearity of the equipment such as transmitters and receivers that are used to process the signals.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures may be employed without departing from the principles described herein.

FIG. 1A shows a CFR engine with pulse cancellation (PC), according to an example.

FIG. 1B shows some representations of signals that may be generated for single carriers, according to an example.

FIG. 1C shows some representations of signals that may be generated for multi-carriers, according to an example.

FIG. 2A shows a flowchart that details a method of improving PA efficiency, according to an example.

FIG. 2B shows a flowchart of a method of configuring the parameters of the PC signal, according to an example.

FIG. 3 shows improvements in Error Vector Magnitude (EVM) in the implementations of pulse cancellation signals, according to an example.

FIG. 4 shows the expansion of the bandwidth of a PC signal, according to an example.

FIG. 5 shows improving EVM on a multi-carrier system, according to an example.

FIG. 6 illustrates a block diagram of a computer system that may be employed for performing the functions and features described herein.

### DETAILED DESCRIPTION

For simplicity and illustrative purposes, the present disclosure is described by referring mainly to examples thereof. In the following description, numerous specific details are set forth in order to provide a thorough understanding of the present disclosure. It will be readily apparent, however, that the present disclosure may be practiced without limitation to these specific details. In other instances, some methods and structures readily understood by one of ordinary skill in the art have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

As described above, heavy demands are made on the linearity of communication equipment, such as transmitters and receivers, that are used to process signals. As a result, the PA, for instance, may need to operate in a linear region. One factor that may affect the linearity of the PA may include Peak to Average Power Ratio (PAPR) for OFDM signals. Generally, the PAPR in mobile communication circuits may be relatively high. High PAPR input to the PA may create more non-linear intermodulation terms that degrade EVM (Error Vector Magnitude) and ACLR (Adjacent Channel Leakage Ratio). To manage adverse effects of the nonlinearity of the PA, for example, the signal PAPR may be reduced through a Crest Factor Reduction (CFR) unit. It should be appreciated that one of the factors that determine the required size of the linear range may be a property of an input signal, typically referred to as a “crest factor.” The crest factor may refer to a ratio between a maximum peak and an average value of a signal. In order to process a signal with a high crest factor, for example, the PA may need to be designed for the maximum peak value, even though the maximum peak value may typically occur very scarcely. Therefore it may be desirable to implement CFR of digital radio signals in order to achieve high PA efficiency.

CFR is a block on OFDM-based transmitters such as 4G and 5G transmitters and beyond but is used for example, in micro/macro cells and massive Multiple-Input Multiple-Output (MIMO) base stations. As discussed above, CFR reduces the Peak to average ratio of the OFDM signals and gives the PA a chance to improve the power efficiency. One of the widely used CFR methods is the Pulse cancellation (PC) method. This method relies on making band-limited pulses that can be added to the main data stream to reduce the high peaks of the signal and not affect the out-of-band emissions. One issue with this method is that CFR may cause a degradation in the signal quality. Maintaining power efficiency and achieving better signal quality in CFR implementations is a challenge. The problem gets more complicated when there are more carriers in the data stream as in 5G signals.

Keeping PAPR low for a given signal quality may therefore help to maintain power efficiency. For multicarrier systems, and pulse cancellation (PC) systems the methods described herein may be effective. In some examples, the systems and methods using such PC methodology may rely on making bandwidth-limited pulses that may be used to cancel high peaks. Any carrier combination and/or any number of carriers may be addressed. For example, even mixed carrier or provider bandwidth may also be accommodated. Using the systems and methods described herein, the pulses may be subtracted from peaks in an in-phase manner to achieve optimal design of pulse for single-carrier and/or multicarrier systems.

In one example for a single carrier PC, the systems and methods described herein may improve signal quality while maintaining PAPR and/or equivalently achieving better power efficiency for given signal quality. Here, PC for the reduction of PAPR may include adding a pulse to the carrier signal in order to reduce the peak of the signal. The pulse cancellation for a single carrier pulse may include combining a windowed or a truncated sinc signal with another window. Sinc (or sine cardinal) signal, as used herein, may normally expand from negative infinity to positive infinity. Truncating a sinc signal, as used herein, may refer to the sinc signal symmetrically expanding from both sides and the sinc function is halted from both the negative and positive sides after the given length is achieved. It may be appreciated that the sinc signal may be truncated symmetrically from the negative and positive sides. The window to be multiplied with the truncated sinc signal may include window functions, such as but not limited to, Tukey, Kaiser, Blackman, Nuttall, Hann, Hamming, Gaussian, Parzan, Welch, Sine, or a combination thereof, and/or any other window function. The multiplication of the truncated sinc with another window signal may help improve the EVM in addition to optimizing the CFR length.

In another example of multi-carrier pulse cancellation, the systems and methods described herein may be implemented as well. In some examples, this may include using similar window functions as described above. In addition, based on the bandwidths and positions of the carriers in a multi-carrier system, the systems and methods may also provide respective equivalent pulse cancellations for each carrier. For example, each of the PC signals may then be further upconverted to the correct position with respect to the carrier signal. Any carrier combination may be thus processed with PC signals as described above. The asymmetric carrier with PC combinations created may include any number of complex pulse cancellations.

In some examples, certain attributes of the PC signal and/or the carrier signal may be changed to decrease CFR and/or increase power efficiency. For example, the bandwidth of the PC signal may be increased. In addition, the quality of the sinc signal after multiplying the windows functions may also be improved. In some examples, the edge of the streaming signal may rise sharply which may be due to any number of hardware issues, such as matching and filtering issues. Interference from other transmitters may also affect the edge of the received signals on the User Equipment (UE). Dampening or shrinking the edge of the PC signal may therefore be another way to improve signal quality.

In addition to the expansion/contraction of the bandwidth of the PC signal, the center frequency of the PC signal may be shifted relative to its corresponding carrier center frequency. It may be appreciated that configuring pulse cancellation for multi-carrier signal, for instance, may involve building a single carrier PC for each corresponding carrier and then upconverting each single carrier PC to a corresponding center frequency of each carrier. The center frequency of each PC signal, which makes up the multicarrier PC signals, may be different from the center frequency of the corresponding carrier signal. This offset from the carrier center frequency may enable combating the edge EVM problem. On certain occasions, the edge of the band may require a better EVM to mitigate problems such as high distortion at the edge of the band due to filters, temperature, etc., and interference at the edge of the signal. Therefore, the two features that customize the PC signal of each carrier may be the bandwidth and the center frequency. These two techniques may enable keeping the PAPR low so that the OFDM signal has higher power efficiency.

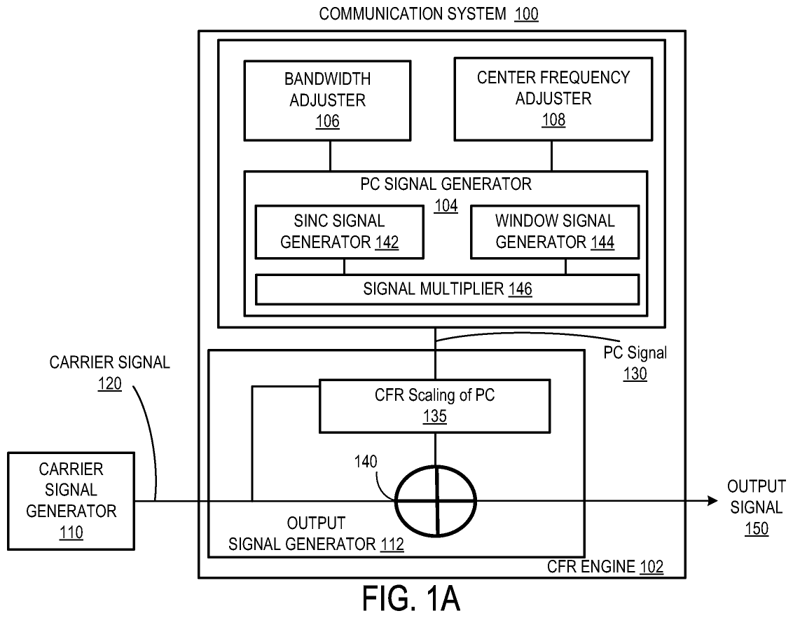

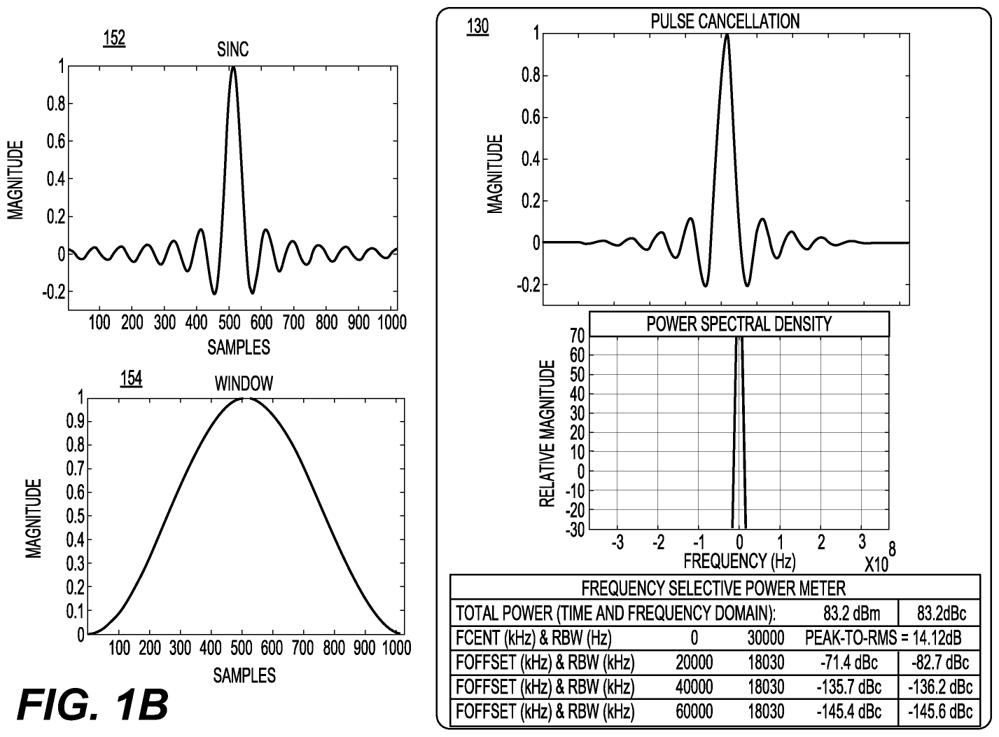

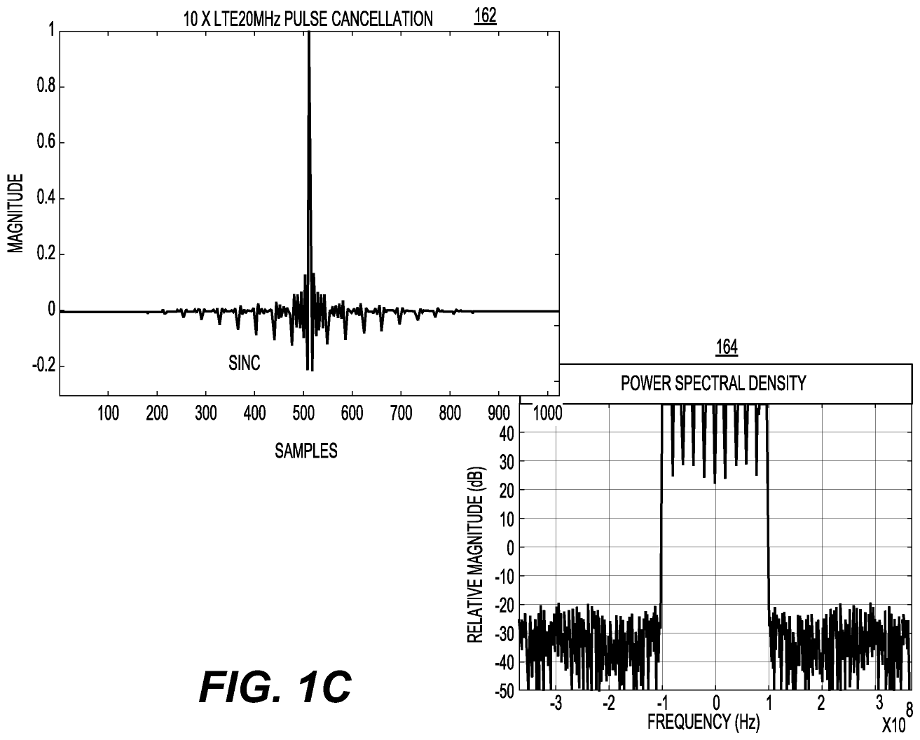

FIG. 1A shows a communication system 100 implementing CFR for controlling the PAPR of a communication signal according to an example. The communication system 100 may include a carrier signal generator 110, a CFR engine 102, and a signal receiver (not shown) that receives the output signal 150. In an example, CFR engine 102 may be implemented at a transmitter within communication system 100. The carrier signal generator 110 may generate a carrier signal 120 which may include an OFDM signal. In an example, the carrier signal 120 may pertain to a single carrier signal or a multi-carrier signal. Since the PAPR ratios of the OFDM signals are high, the carrier signal 120 may be summed 140 with a pulse cancellation signal 130 to produce the output signal 150 which may be transmitted to user equipment (UE) such as a cellular phone, laptop, etc., or another receiver (not shown). The summation 140 of the carrier signal 120 with the scaled pulse cancellation signal 130 may improve the efficiency of the Power Amplifier (PA) transmitting the output signal 150 in addition to other benefits such as improving the bandwidth and signal quality.

The CFR engine 102 includes a PC signal generator 104, a bandwidth adjuster 106, a center frequency adjuster 108, and an output signal generator 112 which scales 135 the PC signal properly based at least on the phase and magnitude of the carrier signals. In an example, the PC signal 130 may include a truncated sinc signal multiplied by another window signal. Accordingly, the PC signal generator 104 may include a sinc signal generator 142, a window signal generator 144, and a signal multiplier 146. The sinc signal generator 142 generates a windowed or truncated sinc signal and the window signal generator 144 generates a window signal. The signal multiplier 146 multiplies the truncated sinc signal with the window signal to generate the PC signal 130.

In an example, the PC signal 130 thus generated may have a configurable bandwidth that is greater than the bandwidth of the carrier signal 120 thereby improving the quality of the resulting output signal 150. For instance, for a 20 Mhz Long-Term Evolution (LTE) signal, the carrier signal bandwidth could be 18 MHz and the PC signal bandwidth may be larger than 18 MHz which may improve the EVM of the target carrier and yet keep the ACP within the limits. However, in some instances, attenuation of the PC signal bandwidth with respect to the carrier signal bandwidth may improve the EVM of the resource blocks (RBs) closer to the edge of the PC signal 130. Accordingly, the bandwidth adjuster 106 adjusts the bandwidth of the PC signal 130 to be increased or decreased as needed to achieve better signal quality within the communication system 100.

Generally, the center frequency is the middle of a communication channel and may also be referred to as the carrier frequency. The bandwidth of the communication channel may accommodate the frequencies of the carrier signal 120. The PC signal 130 generated for the carrier signal 120 may also have its center frequency offset as compared to the carrier center frequency. The center frequency offset of the PC signal 130 enables combating the edge EVM problems. Therefore, the center frequency adjuster 108 may determine the center frequency of the carrier signal 120 and generate the PC signal 130 with a center frequency at an offset from the carrier center frequency.

The PC signal 130 generated as described above may be combined with the carrier signal 120 by an output signal generator 112 to generate the output signal 150 in the case where the carrier signal 120 is a single carrier. However, in the instance where the carrier signal 120 is a multi-carrier signal, a PC signal as described above may be generated for each of the carriers, upconverted by output signal generator 112 via the CFR Scaling 135, and applied to the corresponding carriers in the carrier signal 120.

FIG. 1B shows some representations of signals that may be generated for single carriers according to some examples. As mentioned above, for a single carrier, the sinc signal generator 142 may initially generate a truncated sinc signal 152 and the window signal generator 144 may generate the window function signal 154. The truncated sinc signal 152 may be multiplied with the window function signal 154 by the signal multiplier 146. The window function signal 154 may be based on window functions such as but not limited to, Tukey, Kaiser, Blackman, Nuttall, Hann, Hamming, Gaussian, Parzan, Welch, Sine, etc. In signal processing and statistics, a window function may be a mathematical function that may be zero-valued outside of some chosen interval, normally symmetric around the middle of the interval, usually near a maximum in the middle, and usually tapering away from the middle. Mathematically, when another function or waveform/data sequence is “multiplied” by a window function, the product is also zero-valued outside the interval whereas the part where they overlap is non-zero i.e., the “view through the window”. In an example, the segment of data within the window may be first isolated, and then only that data is multiplied by the window function values. Thus, tapering, not segmentation may be the main purpose of window functions. The PC signal 130 that results from the multiplication between the truncated sinc signal 152 and the other window function signal 154 may provide better Adjacent Channel Power (ACP) and may implement any size. It may further help to improve the EVM while optimizing the CFR length.

The mathematical formulation of the pulse cancellation in accordance with an example is shown below in Eq. (1). In the equation below, the cancellation pulse P_{c}_{ⱼ} for a single carrier cⱼ may be expressed as the dot product of two vectors, the sinc function, and the window function w, as follows:

$${P}_{{c}_{j}} = sinc ( \frac{{B}_{{c}_{j}}}{{f}_{s}} \vec{n} ) * w \qquad Eq . ( 1 )$$

$$where , w = 0.5 * ( 1 + cos ( 2 π ( \vec{m} - 0.5 ) ) ) \qquad Eq . ( 2 )$$

$$\vec{n} = \{ - \frac{{l}_{cfr} - 1}{2} , - \frac{{l}_{cfr} - 1}{2} + 1 , - \frac{{l}_{cfr} - 1}{2} + 2 , … , \frac{{l}_{cfr} - 1}{2} \} \qquad Eq . ( 3 )$$

$$\vec{m} = \{ 0 , \frac{1}{{l}_{cfr} - 1} , \frac{2}{{l}_{cfr} - 1} , … , 1 \} \qquad Eq . ( 4 )$$

where B_{c}_{ⱼ} may represent the bandwidth of the carrier cⱼ in Hz, f_{c}_{ⱼ} may represent the center frequency of the PC signal center frequency for the carrier number cⱼ, fs may represent sampling frequency, w may represent the window size of l_{cfr}, which may be replaced by any windowing method such as Tukey, Kaiser, or another method.

Eq. (5) below shows the center frequency shifting of each carrier, Pₘᵤₗₜᵢ may represent pulse cancellation for a multi-carrier system.

$${P}_{{c}_{j} - shifted} = ( {e}^{( j2 π \vec{n} \frac{{f}_{{c}_{j}}}{{f}_{s}} )} . * {P}_{{c}_{j}} \qquad Eq . ( 5 )$$

Eq. (6) below shows the addition of the cancellation pulses across all carriers to produce a multicarrier pulse cancellation signal, N₀ may represent the total number of carriers, l_{cfr} may represent the pulse cancelation size of the CFR, and ‘.*’ may represent the dot product of two vectors.

Pₘᵤₗₜᵢ=Σcarriers P_{c}_{ⱼ}_{-shifted} Eq. (6)

FIG. 1C shows some representations of signals that may be generated for multi-carriers by the PC signal generator 104, according to some examples. For a multi-carrier system, a PC signal is generated for each carrier based on the bandwidths and positions of the carriers. The PC signals are upconverted to the right position to produce the output signals for each carrier in the multi-carrier system. The PC signal 130 is an example of the pulse cancellation generated by the PC signal generator 104 for a single carrier. For example, if a multi-carrier system has 10 carriers each of a 20 MHz LTE and a total bandwidth of 200 MHz, the corresponding multi-carrier output signal 164 is shown. The multi-carrier output signal 164 for the 10 carriers with ten PC signals for each of the 10 carriers is shown wherein each of the PC signals is upconverted into the right positions. Similarly, PC signals may be generated for any carrier combination. For asymmetric carrier combinations, the PC signal generator 104 may create complex pulse cancellation.

Generally, the bandwidth of the PC signal 130 generated for a carrier may be expanded to be greater than the carrier bandwidth by the bandwidth adjuster 106. This may enable reducing EVM on the multi-carrier system. In addition to the bandwidth adjustment (expansion and contraction), the PC signal generator 104 may also include a center frequency adjuster 108 configured for shifting the center frequency of each of the PC signals on the multiple carriers relative to its carrier frequency. Such center frequency shift enables further reduction of the EVM at the edge of the band.

The configurable bandwidth for the pulse cancellation signals may be represented as shown below in Equation 7, where, B_{c}_{ⱼ} may represent the bandwidth of the carrier c in Hz:

$${B}_{{c}_{j}} = \frac{{f}_{s}}{⌈ {f}_{s} / {bw}_{j} ⌉ + {bw}_{offset \_ j}} \qquad Eq . ( 7 )$$

where, bwⱼ may represent the signal bandwidth of the carrier j, bw_{offset_j} may represent an adjustment of the bandwidth of the pulse cancellation for carrier j. Negative numbers may expand the pulse cancellation bandwidth while positive numbers may cause a contraction of the pulse cancellation bandwidth. This parameter i.e., bw_{offset_j} may also be a non-integer. It should also be appreciated that the function ┌ ┐ may represent the closest higher integer number.

For each given carrier, it should be appreciated that bandwidth may be expanded beyond the carrier bandwidth. For instance, for a 20 Mhz LTE signal, the signal bandwidth could be 18 MHz. However, the pulse cancellation bandwidth, B_{c}_{ⱼ} maybe larger than 18 MHz where it may improve the EVM of the target carrier and yet keep the ACP well within the limits. B_{c}_{ⱼ} may also contract compared to signal bandwidth. This has been shown to improve the EVM of the resource blocks (RBs) that are closer to the edge of the band. This may be a helpful tool to mitigate the issues when front-end Radio Frequency Hardware (RF HW) affects the EVM of the edge RBs. Eq. (8) shown below represents a calculation for the modification of the length of the pulse cancellation which may enable one way to achieve better ACP and to further improve the ACP:

$${l}_{cfr \_ opt} = ⌊ \frac{{l}_{cfr}}{{f}_{s} / {B}_{{c}_{j}}} ⌋ * \frac{{f}_{s}}{{B}_{{c}_{j}}} - 2 \qquad Eq . ( 8 )$$

It may be appreciated that the length of the pulse cancellation may be chosen to guarantee that the ACLR of the carrier signal stays within a specified limit. Within a range of PC length of interest, there may be other ways in accordance with other examples to calculate the length of the PC signal that provides optimum ACLR.

In addition to the bandwidth expansion/contraction, the center frequency of each pulse cancellation, f_{c}_{ⱼ} is shifted relative to its corresponding carrier center frequency. This offset from carrier center frequency is one way to combat the Edge EVM problem. There may be occasions where the band requires better EVM at the edge of the signal to mitigate problems like: (i) high distortion at the edge of the band due to filters, temperature, and, (ii) interference at the edge of the signal.

It may be appreciated if fc is the center frequency vector list of the pulse cancellation signal, then for normal situations, the center frequency carrier of each signal carrier component may be the same. For each carrier component, its corresponding center frequency may have an offset frequency from the PC signal center frequency. Therefore, two features that help to customize each carrier pulse cancellation are the bandwidth and the center frequency. These two techniques enable keeping the PAPR of the output signal 150 low thereby maintaining higher power efficiency.

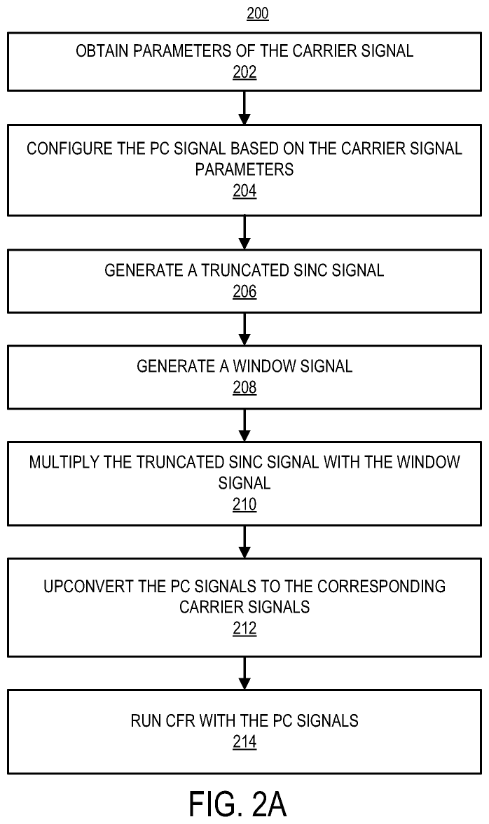

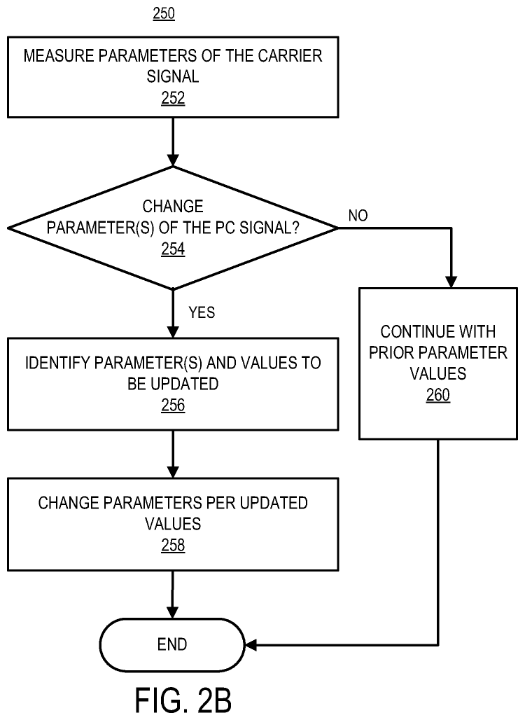

FIG. 2A shows flowchart 200 of a method of improving PA efficiency using a pulse cancellation signal in accordance with an example. The method begins at 202, where parameters such as the bandwidth and the center frequency of the carrier signal 120 are obtained. At 204, the PC signal 130 to be applied to the carrier signal 120 is configured so that the parameters such as the bandwidth and the center frequency of the PC signal are based on the parameters of the carrier signal 120. In an example, the parameters of the PC signal 130 may be initiated with some default numbers or example initial values. In an example, the CFR engine 102 may be coupled to a computing system including processing and data storage resources as described herein so that the signal parameters may be received and supplied to the signal generator(s) as needed. In an example, the bandwidth of the PC signal 130 may be set to be higher than the bandwidth of the carrier signal 120. Such expansion of the PC signal 130 bandwidth over the bandwidth of the carrier signal 120 may provide for better signal quality. Another parameter that may be set includes the center frequency of the PC signal 130 which is designed to be at some offset from the center frequency of the carrier signal 120.

At 206, the truncated sinc signal 152 e.g., with the bandwidth determined for the PC signal 130 is generated. At 208, the window signal 154 is generated using one or more of is one of Turkey, Kaiser, Blackman, Nuttall, Hann, Hamming, Gaussian, Parzan, Welch, and Sine signals. At 210, the truncated sinc signal 152 is multiplied by a window function signal 154. In the case of a multi-carrier signal, at 208, each PC of the given carrier is upconverted by the center frequency assigned in 204. At 212, all the upconverted PC signals corresponding to the carriers are aggregated. At 214, CFR may run with this designed PC of 210 for the current communication session at a given clipping level. The method described above may apply to multi-carrier signals wherein corresponding PC signals are generated for each of the carriers, whereas for a single-carrier signal, the method described above may be executed to generate one PC signal corresponding to the single carrier.

FIG. 2B shows a flowchart 250 of a method of configuring the parameters of the PC signal 130 in accordance with an example. At 252, the parameters, such as but not limited to EVM, ACLR, and PAPR of the output signal 150 within the communication system 100 may be measured. Based on the measurements at 252, it is determined at 254 if any PC signal parameter, needs to be changed. Various thresholds may be configured, for example, within the CFR engine 102 for the different output signal parameters to enable the determinations regarding the changes to be made to the PC signal parameters to maintain the output signal quality. If it is determined at 254 that no PC signal parameters need to be changed, prior parameter values are continued for the PC signal at 260 and the method terminates on the end block.

If it is determined at 254 that one or more of the parameters e.g., the bandwidth or the center frequency of the PC signal(s) are to be changed, the parameters that need to be changed, and the change(s) to be made or the updated values are determined at 256. One or more of the new bandwidth and center frequencies may be adjusted at 258 to the updated values, for example, to optimize over ACLR, EVM, and PAPR and rerun this iteration. This technique or sequence of actions may be achieved in offline processing to design the PC signal for a given carrier configuration. When the PC signal is designed and configured per the newer parameters, it may be used during the run time and maintained until changes in the communication system 100 necessitate the corresponding changes in the PC signal parameters. It may be appreciated that the method of FIG. 2B may be used and applied for any pulse cancellation design.

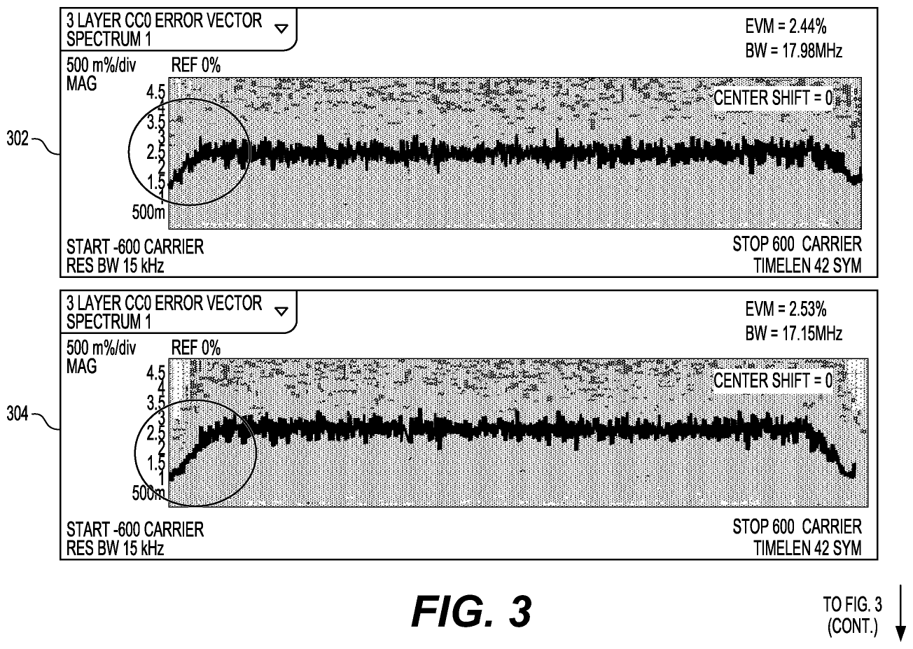

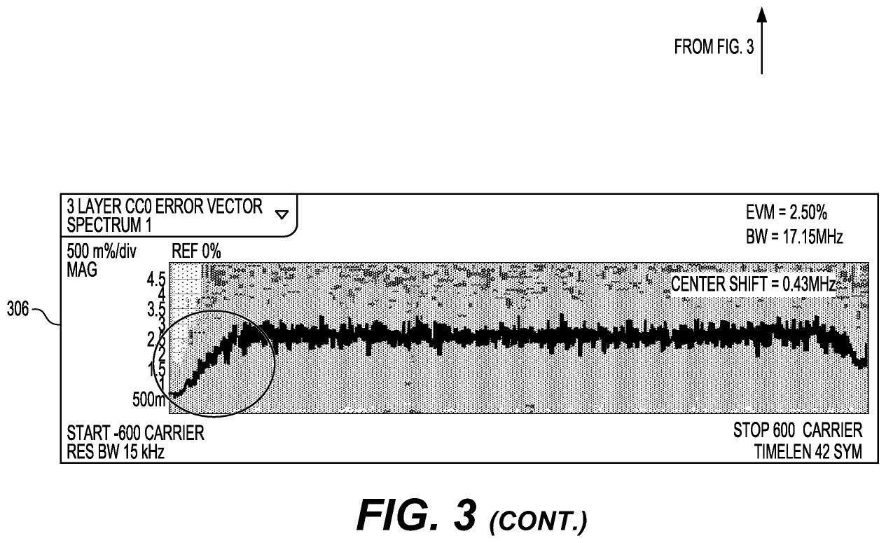

FIG. 3 shows improvements in the EVM for the implementations of pulse cancellation signals in accordance with some examples. In many radios, band edge RBs suffer from distortion that could be due to filter/temperature/Radio Frequency (RF) matching drift for all radios or specific transmission lines. Contracting and shifting the PC may provide better EVM for the edge RBs. In the spectrum at 302, the signal edge as shown in the circled portion is at about 1.5. The spectrum at 306 is obtained when the PC signal bandwidth is contracted without the frequency center shift. It may be seen within the circle at 304 that the signal edge is about 1.2. At 306, the shifting of the center frequency after shrinking the PC signal bandwidth is shown. It may be seen within the circle at 306 that the signal edge is below 1. In summary, the PC signal at 302 shows the initial EVM per frequency tone. At 304 shows improving the edge tone EVM within the PC signal by contracting the pulse cancellation bandwidth. While the spectrum at 306 shows the improvement in the EVM obtained for the right edge of the spectrum by the cumulative effect of shifting the center frequency of the PC signal in addition to contracting the pulse cancellation bandwidth is shown.

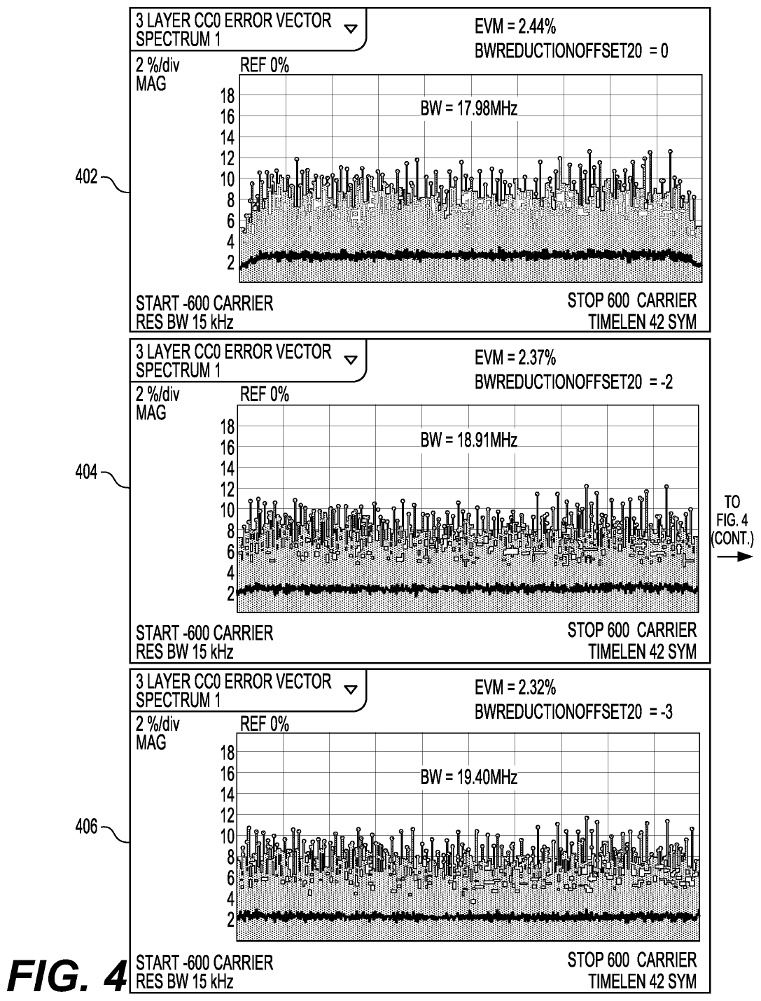

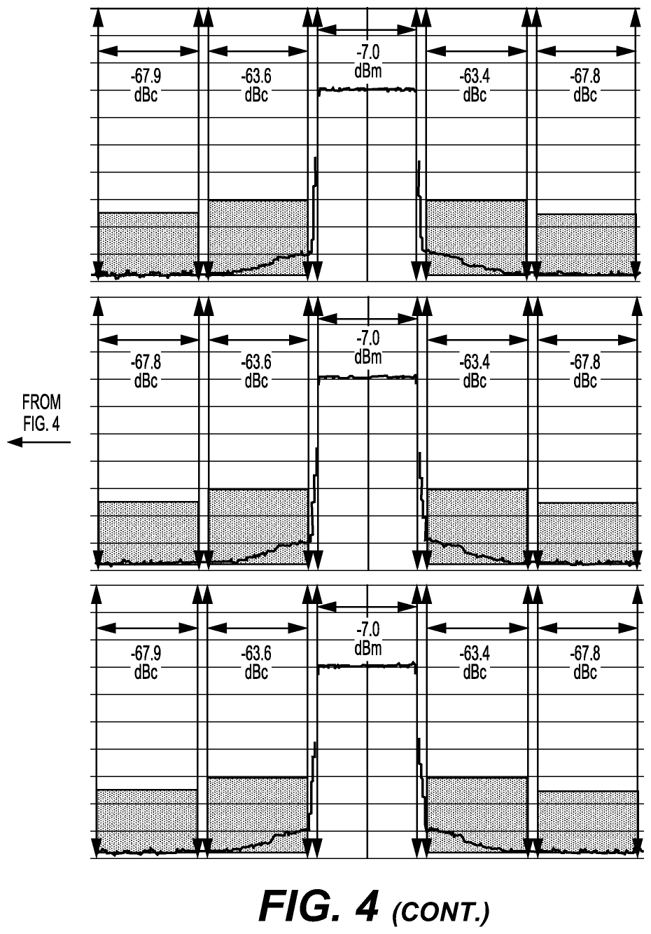

FIG. 4 shows the effect of an expansion of the bandwidth of the PC signal in a carrier circuit in accordance with some examples. The changes in the EVM are displayed in the various diagrams. At 402, the EVM is about 2.44% while the bandwidth of the PC signal is at 17.98 MHz. At 404, the EVM is reduced to 2.37% while the bandwidth of the PC signal is increased to 18.91 MHz. At 406, the EVM has further reduced to 2.32% when the bandwidth of the PC signal is further increased to 19.40 MHz. It may be noted that the bandwidth of the carrier signal on the RHS remains stable.

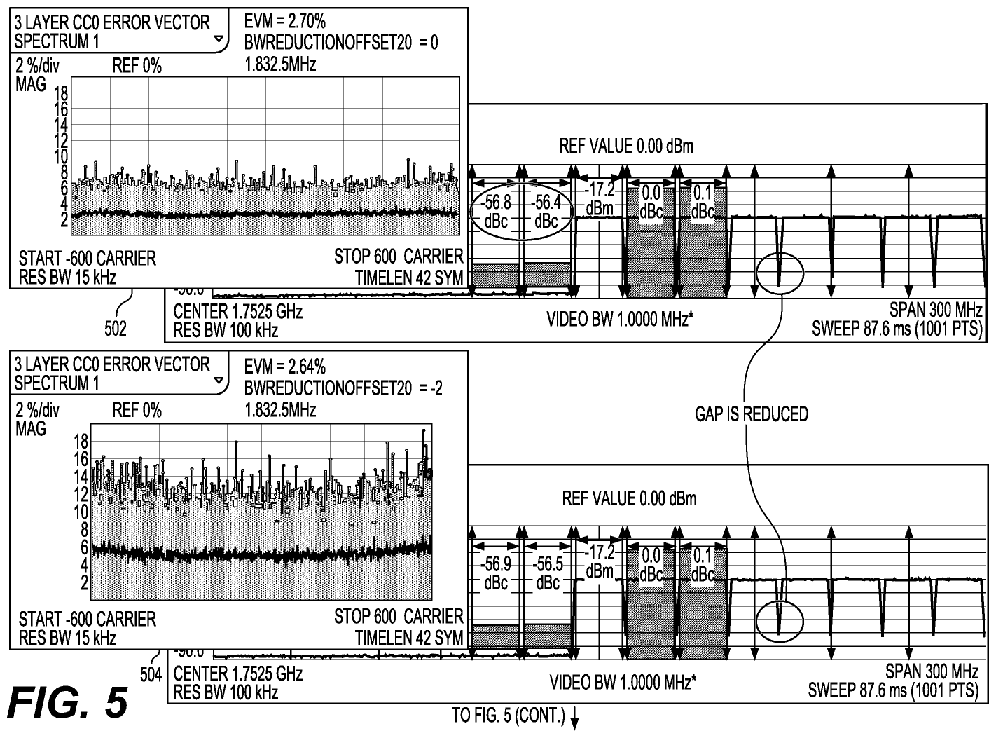

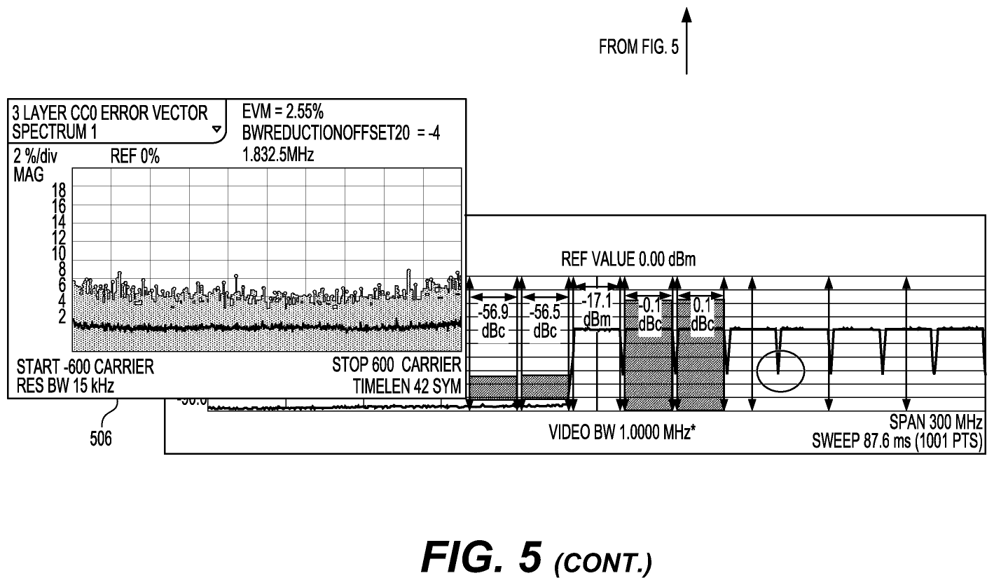

FIG. 5 shows improving EVM on a multi-carrier system in accordance with some examples. The multi-carrier system uses 10 channels of 20 MHz each. The changes in the EVM are displayed in the various diagrams. At 502, the EVM is about 2.70%. At 504, the EVM is reduced to 2.67%. At 506, the EVM has further reduced to 2.55%. It may be noted that the bandwidth of the carrier signal on the RHS remains stable.

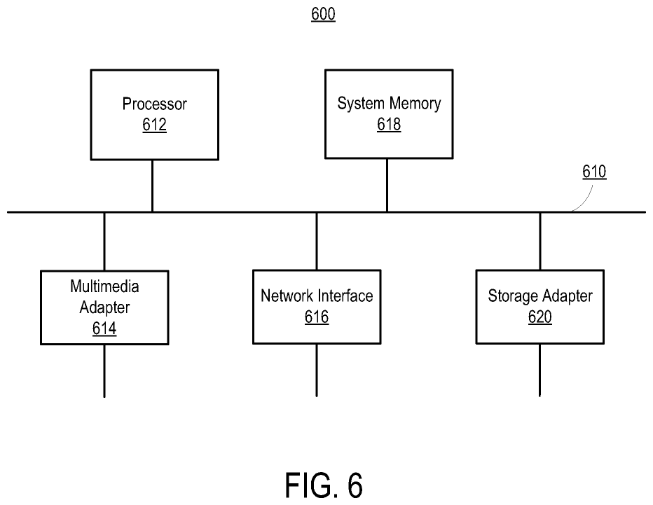

FIG. 6 illustrates a block diagram of a computer system 600 that may be employed for performing the functions and features described herein. The computer system 600 may include, among other things, an interconnect 610, a processor 612, a multimedia adapter 614, a network interface 616, a system memory 618, and a storage adapter 620.

The interconnect 610 may interconnect various subsystems, elements, and/or components of the computer system 600. As shown, the interconnect 610 may be an abstraction that may represent any one or more separate physical buses, point-to-point connections, or both, connected by appropriate bridges, adapters, or controllers. In some examples, the interconnect 610 may include a system bus, a peripheral component interconnect (PCI) bus or PCI-Express bus, a Hyper Transport or industry standard architecture (ISA)) bus, a small computer system interface (SCSI) bus, a universal serial bus (USB), IIC (I2C) bus, or an Institute of Electrical and Electronics Engineers (IEEE) standard 1396 bus, or “firewire,” or other similar interconnection element.

In some examples, the interconnect 610 may allow data communication between the processor 612 and system memory 618, which may include non-transitory, processor-readable medium such as read-only memory (ROM) or flash memory (neither shown), and random access memory (RAM) (not shown). It should be appreciated that the RAM may be the main memory into which an operating system and various application programs including processing instructions may be loaded. The ROM or flash memory may contain, among other code, the Basic Input-Output system (BIOS) which controls basic hardware operations such as the interaction with one or more peripheral components.

The processor 612 may be the central processing unit (CPU) of the computing device and may control the overall operation of the computing device. In some examples, the processor 612 may accomplish this by executing software or firmware stored in system memory 618 or other data via the storage adapter 620. The processor 612 may be or may include, one or more programmable general-purpose or special-purpose microprocessors, digital signal processors (DSPs), programmable controllers, application-specific integrated circuits (ASICs), programmable logic devices (PLDs), trust platform modules (TPMs), field-programmable gate arrays (FPGAs), other processing circuits, or a combination of these and other devices.

The multimedia adapter 614 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 616 may provide the computing device with the ability to communicate with a variety of remote devices over a network and may include, for example, an Ethernet adapter, a Fibre Channel adapter, and/or other wired- or wireless-enabled adapter. The network interface 616 may provide a direct or indirect connection from one network element to another, and facilitate communication between various network elements.

The storage adapter 620 may connect to a standard computer-readable medium for storage and/or retrieval of information, such as a fixed disk drive (internal or external).

Many other devices, components, elements, or subsystems (not shown) may be connected similarly to the interconnect 810 or via a network. Conversely, all of the devices shown in FIG. 6 need not be present to practice the present disclosure. The devices and subsystems may be interconnected in different ways from that shown in FIG. 6. Code to implement the present disclosure may be stored in computer-readable storage media such as one or more of system memory 618 or other storage. Code to implement the present disclosure may also be received via one or more interfaces and stored in memory. The operating system provided on computer system 600 may be MS-DOS®, MS-WINDOWS®, OS/2®, OS X®, IOS®, ANDROID®, UNIX®, Linux®, or another operating system.

As mentioned above, there may be numerous ways to configure or position the various elements of the systems such as the PAs, transmitters, receivers, base stations, etc. Adjusting these and other components may also provide a more efficient or compact design for the communication paths. In this way, other electrical, thermal, mechanical, and/or design advantages may also be obtained.

While examples described herein are directed to configurations as shown, it should be appreciated that any of the components described or mentioned herein may be altered, changed, replaced, or modified, in size, shape, numbers, or material, depending on the application or use case, and adjusted for desired resolution or optimal measurement results.

It should be appreciated that the systems and methods described herein may facilitate more reliable and accurate power measurements. It should also be appreciated that the systems and methods, as described herein, may also include or communicate with other components not shown. For example, these may include external processors, counters, analyzers, computing devices, and other measuring devices or systems. This may also include middleware (not shown) as well. The middleware may include software hosted by one or more servers or devices. Furthermore, it should be appreciated that some of the middleware or servers may or may not be needed to achieve functionality. Other types of servers, middleware, systems, platforms, and applications not shown may also be provided at the back end to facilitate the features and functionalities of the communication system.

Moreover, single components may be provided as multiple components, and vice versa, to perform the functions and features described herein. It should be appreciated that the components of the system described herein may operate at partial or full capacity, or they may be removed entirely. It should also be appreciated that analytics and processing techniques described herein with respect to the communication system measurements, for example, may also be performed partially or in full by other various components of the overall system.

It should be appreciated that data stores may also be provided to the apparatuses, systems, and methods described herein and may include volatile and/or nonvolatile data storage that may store data and software or firmware including machine-readable instructions. The software or firmware may include subroutines or applications that perform the functions of the measurement system and/or run one or more applications that utilize data from the measurement or other communicatively coupled systems.

The various components, circuits, elements, components, and interfaces, may be any number of mechanical, electrical, hardware, network, or software components, circuits, elements, and interfaces that serves to facilitate communication, exchange, and analysis of data between any number of or combination of equipment, protocol layers, or applications. For example, the components described herein may each include a network or communication interface to communicate with other servers, devices, components, or network elements via a network or other communication protocol.

Although examples are directed to a single carrier and multi-carrier communication systems, it should be appreciated that the systems and methods described herein may also be used in other various systems and other implementations.

With additional advantages that include improved quality, bandwidth, and single and multi-carrier compatibility, the systems and methods described herein may be beneficial in many original equipment manufacturer (OEM) applications, where they may be readily integrated into various and existing network equipment, sensor systems, test and measurement instruments, or other systems and methods. The systems and methods described herein may provide simplicity and adaptability to small or large communication devices. Ultimately, the systems and methods described herein may increase bandwidth and quality while concurrently minimizing the adverse effects of traditional systems.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A communication system, comprising:
a Crest Factor Reduction (CFR) engine comprising a pulse cancellation (PC) signal generator that generates a pulse cancellation (PC) signal for a carrier signal, wherein the pulse cancellation (PC) signal has:
a configurable bandwidth greater than a bandwidth of the carrier signal; and
a center frequency offset from a center frequency of the carrier signal.

2. The communication system of claim 1, wherein the pulse cancellation (PC) signal generator further comprises:
a sinc signal generator that generates a truncated sinc signal; and
a window signal generator that generates a window signal.

3. The communication system of claim 2, wherein the pulse cancellation (PC) signal generator further comprises:
a signal multiplier that generates the pulse cancellation (PC) signal by multiplying the truncated sinc signal with the window signal.

4. The communication system of claim 3, wherein the window signal comprises at least one of the following signals: Turkey, Kaiser, Blackman, Nuttall, Hann, Hamming, Gaussian, Parzan, Welch, or Sine.

5. The communication system of claim 1, wherein the Crest Factor Reduction (CFR) engine further comprises:
an output signal generator that generates an output signal by combining the pulse cancellation (PC) signal with the carrier signal.

6. The communication system of claim 5, wherein the carrier signal comprises at least one of a single-carrier signal or a multi-carrier signal.

7. The communication system of claim 6, wherein the carrier signal is the multi-carrier signal, and the pulse cancellation (PC) signal generator generates the PC signal for the multi-carrier signal by upconverting an equivalent pulse cancellation (PC) signal into a position to be combined with a corresponding carrier signal of the multi-carrier signal.

8. The communication system of claim 1, further comprising:
a bandwidth adjuster that maintains an Error Vector Magnitude (EVM) of edge resource blocks (RBs) of the pulse cancellation (PC) signal by expanding or contracting the configurable bandwidth of the pulse cancellation (PC) signal with respect to the bandwidth of the carrier signal.

9. The communication system of claim 8, further comprising:
a center frequency adjuster that adjusts the center frequency of the pulse cancellation (PC) signal to be at an offset from the center frequency of the carrier signal.

10. A crest factor reduction (CFR) method, comprising:
determining a bandwidth of a carrier signal;
configuring a pulse cancellation (PC) signal for the carrier signal with greater bandwidth than the bandwidth of the carrier signal;
configuring a center frequency of the pulse cancellation (PC) signal at an offset from a center frequency of the carrier signal; and
canceling at least one high peak in the carrier signal by combining the pulse cancellation (PC) signal with the carrier signal.

11. The crest factor reduction (CFR) method of claim 10, wherein configuring the pulse cancellation (PC) signal for the carrier signal further comprises:
generating a truncated sinc signal; and
combining the truncated sinc signal with another window signal.

12. The crest factor reduction (CFR) method of claim 11, wherein generating the pulse cancellation (PC) signal further comprises:
generating the pulse cancellation (PC) signal as:
$${P}_{{c}_{j}} = sinc ( \frac{{B}_{{c}_{j}}}{{f}_{s}} \vec{n} ) . * w ,$$
$$wherein : w = 0.5 * ( 1 + cos ( 2 π ( \vec{m} - 0.5 ) ) )$$
$$\vec{n} = \{ - \frac{{l}_{cfr} - 1}{2} , - \frac{{l}_{cfr} - 1}{2} + 1 , - \frac{{l}_{cfr} - 1}{2} + 2 , … , \frac{{l}_{cfr} - 1}{2} \} ,$$
$$\vec{m} = \{ 0 , \frac{1}{{l}_{cfr} - 1} , \frac{2}{{l}_{cfr} - 1} , … , 1 \} ,$$
wherein:
B_{c}_{ⱼ} represents the bandwidth of carrier cⱼ in Hz,
fₛ represents sampling frequency,
w represents a window of size l_{cfr},
P_{c}_{ⱼ} represents the pulse cancellation for a single carrier cⱼ,
l_{cfr} represents the pulse cancellation size of the Crest Factor Reduction (CFR), and
(*) represents a dot product.

13. The crest factor reduction (CFR) method of claim 12, wherein the carrier signal is a single-carrier signal.

14. The crest factor reduction (CFR) method of claim 12, wherein the carrier is signal is a multi-carrier signal, and generating the pulse cancellation (PC) signal further comprises:
setting the pulse cancellation (PC) signal as:
$${P}_{{c}_{j} - shifted} = ( {e}^{( j2 π \vec{n} \frac{{f}_{{c}_{j}}}{{f}_{s}} )} . * {P}_{{c}_{j}} ;$$
$$and {P}_{multi} = {\sum }_{carriers} {P}_{{c}_{j} - shifted} ,$$
wherein f_{c}_{ⱼ} represents the center frequency of the pulse cancellation (PC) signal for carrier number, cⱼ.

15. The crest factor reduction (CFR) method of claim 12, wherein configuring the bandwidth of the pulse cancellation (PC) signal further comprises:
configuring the bandwidth, B_{c}_{ⱼ}, of the pulse cancellation (PC) signal as:
$${B}_{{c}_{j}} = \frac{{f}_{s}}{⌈ {f}_{s} / {bw}_{j} ⌉ + {bw}_{offset \_ j}}$$
wherein:
bwⱼ represents a bandwidth of the carrier cⱼ,
bw_{offset_j} represents an adjustment over the bandwidth of the pulse cancellation for carrier j.

16. The crest factor reduction (CFR) method of claim 15, further comprising:
setting a length l_{cfr_opt} of the pulse cancellation signal as:
$${l}_{cfr \_ opt} = ⌊ \frac{{l}_{cfr}}{{f}_{s} / {B}_{{c}_{j}}} ⌋ * \frac{{f}_{s}}{{B}_{{c}_{j}}} - 2.$$

17. The crest factor reduction (CFR) method of claim 11, further comprising:
maintaining Adjacent Channel Power (ACP) by expanding or contracting the bandwidth of the pulse cancellation (PC) signal while maintaining the bandwidth of the pulse cancellation (PC) signal greater than the bandwidth of the carrier signal.

18. A non-transitory processor-readable medium comprising instructions, which when executed by at least one processor, cause the at least one processor to:
measure Error Vector Magnitude (EVM) of an output signal, wherein:
the output signal is generated by combining a pulse cancellation (PC) signal with a corresponding carrier signal; and
a configurable bandwidth of the pulse cancellation (PC) signal is greater than a bandwidth of the carrier signal;
determine that at least one parameter of the pulse cancellation (PC) is to be changed based at least on a value of the Error Vector Magnitude (EVM);
change the configurable bandwidth of the pulse cancellation (PC) signal to an updated bandwidth; and
generate an updated output signal by combining the pulse cancellation (PC) signal with the updated bandwidth with the carrier signal.

19. The non-transitory, processor-readable medium of claim 18, further is comprising instructions to:
determine that a center frequency of the pulse cancellation (PC) signal is to be adjusted to be at an offset with respect to a center frequency of the carrier signal.

20. The non-transitory, processor-readable medium of claim 18, further comprising instructions to:
maintain the configurable bandwidth of the pulse cancellation (PC) signal greater than the bandwidth of the carrier signal.
